(19) United States
(12) Patent Application Publication
(10) Pub. No.: US 2024/0090389 A1
(43) Pub. Date: Mar. 21, 2024

(54) COATING COMPOSITIONS INCLUDING CO-SURFACTANTS

(71) Applicant: Apeel Technology, Inc., Goleta, CA (US)

(72) Inventors: David Fisher, Goleta, CA (US); Krishnan Chari, Goleta, CA (US); Stanley Zhang, Goleta, CA (US)

(21) Appl. No.: 18/239,565

(22) Filed: Aug. 29, 2023

Related U.S. Application Data
(60) Provisional application No. 63/401,934, filed on Aug. 29, 2022.

(51) Int. Cl. A01G 13/02

(52) U.S. Cl. CPC A01G 13/02

(57) ABSTRACT

The present disclosure relates to compositions including monoglycerides and co-surfactants. An exemplary embodiment includes about 40 wt % to about 99 wt % of one or more monoglycerides of a C₄-C₂₈ fatty acid, about 0.1 wt % to about 20 wt % of one or more salts of a C₄-C₂₈ fatty acid, and about 0.1 wt % to about 20 wt % of one or more zwitterions.

### CROSS-REFERENCE TO RELATED APPLICATION

This application claims the benefit of priority to U.S. application Ser. No. 63/401,934, filed on Aug. 29, 2022, the contents of which are hereby incorporated by reference.

### TECHNICAL FIELD

The present disclosure relates to coatings for agricultural products.

### BACKGROUND

Common agricultural products are susceptible to degradation and decomposition (i.e., spoilage) when exposed to the environment. Such agricultural products can include, for example, eggs, fruits, vegetables, produce, seeds, nuts, flowers, and/or whole plants (including their processed and semi-processed forms). Non-agricultural products (e.g., vitamins, candy, etc.) are also vulnerable to degradation when exposed to the ambient environment. The degradation of the agricultural products can occur via abiotic means as a result of evaporative moisture loss from an external surface of the agricultural products to the atmosphere, and/or oxidation by oxygen that diffuses into the agricultural products from the environment, and/or mechanical damage to the surface, and/or light-induced degradation (i.e., photodegradation). Furthermore, biotic stressors such as, for example, bacteria, fungi, viruses, and/or pests can also infest and decompose the agricultural products.

Conventional approaches to preventing degradation, maintaining quality, and increasing the life of agricultural products include refrigeration and/or special packaging. Refrigeration requires capital-intensive equipment, demands constant energy expenditure, can cause damage or quality loss to the product if not carefully controlled, and must be actively managed. Also, the benefits of refrigeration are lost upon interruption of a temperature-controlled supply chain. Special packaging can also require expensive equipment, consume packaging material, increase transportation costs, and require active management. Despite the benefits that can be afforded by refrigeration and special packaging, the handling and transportation of the agricultural products can cause surface abrasion or bruising that is aesthetically displeasing to the consumer and can serve as a point of ingress for bacteria and fungi. Moreover, the expenses associated with such approaches can add to the cost of the agricultural product.

### SUMMARY

Provided herein is a composition including one or more monoglycerides of a C₄-C₂₈ fatty acid, present in a total amount of about 40 wt % to about 99 wt % of the composition, one or more salts of a C₄-C₂₈ fatty acid, present in a total amount of 0.1 wt % to about 20 wt % of the composition, and one or more zwitterions, present in a total amount of 0.1 wt % to about 20 wt % of the composition.

Also provided herein is a composition including one or more monoglycerides of a C₄-C₂₈ fatty acid, one or more salts of a C₄-C₂₈ fatty acid, and one or more zwitterions. A ratio of a total number of moles of the one or more monoglycerides to a total number of moles of the one or more salts and the one or more zwitterions is about 100:1 to about 4:1.

Also provided herein is a mixture of a composition described herein and a solvent.

Also provided herein is a coated agricultural product including an agricultural product and a layer disposed on a surface of the agricultural product, the layer including a composition described herein.

Also provided herein is a method of coating an agricultural product, the method including contacting a surface of the agricultural product with a mixture including a coating agent and a solvent, and removing at least a portion of the solvent to form a coating on the surface of the agricultural product. The coating agent includes one or more monoglycerides of a C₄-C₂₈ fatty acid, one or more salts of a C₄-C₂₈ fatty acid, and one or more zwitterions. A ratio of a total number of moles of the one or more monoglycerides to a total number of moles of the one or more salts and the one or more zwitterions present in the coating agent is about 100:1 to about 4:1.

Also provided herein is a method of coating an agricultural product, the method including contacting a surface of the agricultural product with a mixture described herein, and removing at least a portion of the solvent to form a coating on the surface of the agricultural product.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a composition comprising:
one or more monoglycerides of a C₄-C₂₈ fatty acid, present in a total amount of about 40 wt % to about 99 wt % of the composition;
one or more salts of a C₄-C₂₈ fatty acid, present in a total amount of about 0.1 wt % to about 20 wt % of the composition; and
one or more zwitterions, present in a total amount of 0.1 wt % to about 20 wt % of the composition.

Embodiment 2 is the composition of embodiment 1, wherein the one or more monoglycerides are present in a total amount of about 70 wt % to about 99 wt %.

Embodiment 3 is the composition of embodiment 1, wherein the one or more monoglycerides are present in a total amount of about 80 wt % to about 98 wt %.

Embodiment 4 is the composition of any of embodiments 1-3, wherein the one or more salts are present in a total amount of about 1 wt % to about 10 wt % of the composition.

Embodiment 5 is the composition of any of embodiments 1-3, wherein the one or more salts are present in a total amount of about 2 wt % to about 10 wt % of the composition.

Embodiment 6 is the composition of any of embodiments 1-5, wherein the one or more zwitterions are present in a total amount of about 1 wt % to about 10 wt % of the composition.

Embodiment 7 is the composition of any of embodiments 1-5, wherein the one or more zwitterions are present in a total amount of about 2 wt % to about 10 wt % of the composition.

Embodiment 8 is the composition of any of embodiments 1-7, further comprising an inorganic salt.

Embodiment 9 is the composition of embodiment 8, wherein the one or more inorganic salts comprises sodium chloride, potassium chloride, sodium bromide, potassium bromide, or any combination thereof.

Embodiment 10 is a composition comprising:
one or more monoglycerides of a C₄-C₂₈ fatty acid;
one or more salts of a C₄-C₂₈ fatty acid; and
one or more zwitterions;
   wherein a ratio of a total number of moles of the one or more monoglycerides to a total number of moles of the one or more salts and the one or more zwitterions is about 100:1 to about 4:1.

Embodiment 11 is the composition of embodiment 10, wherein the ratio of the total number of moles of the one or more monoglycerides to the total number of moles of the one or more salts and the one or more zwitterions is about 100:1: to about 6:1.

Embodiment 12 is the composition of embodiment 10, wherein the ratio of the total number of moles of the one or more monoglycerides to the total number of moles of the one or more salts and the one or more zwitterions is about 50:1: to about 8:1.

Embodiment 13 is the composition of any of embodiments 10-12, wherein a ratio of a total number of moles of the one or more salts to a total number of moles of the one or more zwitterions is about 10:1 to about 1:10.

Embodiment 14 is the composition of any of embodiments 10-12, wherein a ratio of a total number of moles of the one or more salts to a total number of moles of the one or more zwitterions is about 1:1 to about 1:10.

Embodiment 15 is the composition of any of embodiments 10-14, wherein the one or more monoglycerides, the one or more salts, and the one or more zwitterions make up at least about 80 wt % of the composition

Embodiment 16 is the composition of any of embodiments 1-15, wherein the composition comprises a lecithin or a hydrolyzed lecithin comprising at least one of the zwitterions.

Embodiment 17 is the composition of any of embodiments 1-16, wherein at least one of the zwitterions comprises:
a positively charged group comprising a quaternary ammonium group or a phosphonium group; and
a negatively charged group comprising a phosphate group, a sulfonate group, or a carboxylate group.

Embodiment 18 is the composition of any of embodiments 1-16, wherein at least one of the zwitterions comprises a betaine, a phosphatidylcholine, a lysophosphatidylcholine, a hydroxysultaine, or an amphoacetate salt.

Embodiment 19 is the composition of any of embodiments 1-18, wherein at least one of the zwitterions comprises a compound of Formula III-i or Formula III-ii:

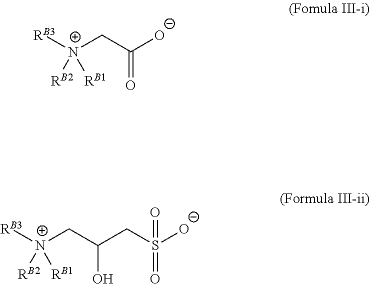

wherein:
   R^{B1}, R^{B2}, and R^{B3} are each independently selected from C₁-C₂₂ alkyl and (C₁-C₆ alkyl)-NR^{B4}C(O)R^{H};
   each occurrence of R^{B4} is independently H or C₁-C₆ alkyl; and
   each occurrence of R^{H} is independently a C₃-C₂₁ side chain.

Embodiment 20 is the composition of embodiment 19, wherein R^{B1} and R^{B2} are each C₁-C₆ alkyl.

Embodiment 21 is the composition of embodiment 19 or embodiment 20, wherein R^{B3} is C₁₀-C₂₀alkyl.

Embodiment 22 is the composition of any of embodiments 1-21, wherein at least one of the zwitterions comprises a compound of Formula IIIA-i or Formula IIIA-ii:

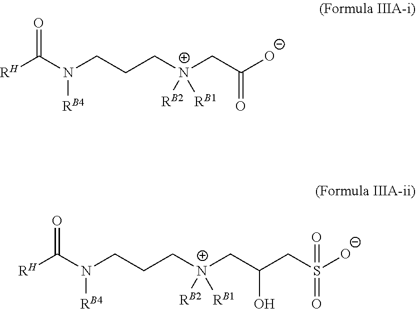

wherein:
   R^{B1} and R^{B2} are each independently selected from C₁-C₆ alkyl;
   R^{B4} is H or C₁-C₆ alkyl; and
   R^{H} is a C₃-C₂₁ side chain.

Embodiment 23 is the composition of embodiment 22, wherein R^{B4} is H.

Embodiment 24 is the composition of any of embodiments 1-23, wherein at least one of the zwitterions comprises a compound of Formula IV:

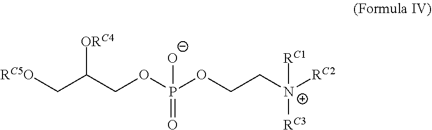

wherein:
   R^{C1}, R^{C2}, and R^{C3} are each independently selected from C₁-C₆ alkyl;
   R^{C4} and R^{C5} are each independently selected from H and C(O)R^{H};
   each occurrence of R^{H} is independently a C₃-C₂₁ side chain; and
   at least one of R^{C4} and R^{C5} is not H.

Embodiment 25 is the composition of embodiment 24, wherein R^{C4} and R^{C5} are each independently C(O)R^{H}.

Embodiment 26 is the composition of embodiment 24 or embodiment 25, wherein R^{C4} is H and R^{C5} is C(O)R^{H}.

Embodiment 27 is the composition of any of embodiments 1-26, wherein each of the one or more monoglycerides independently comprises a compound of Formula I-i or Formula I-ii:

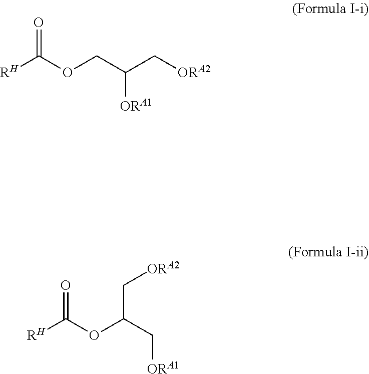

wherein:
   R^{A1} and R^{A2} are each independently selected from H and C₁-C₆ alkyl; and
   R^{H} is a C₃-C₂₇ side chain.

Embodiment 28 is the composition of embodiment 27, wherein R^{A1} and R^{A2} are each H.

Embodiment 29 is the composition of embodiment 27 or embodiment 28, wherein R^{H} is a saturated, unsubstituted side chain.

Embodiment 30 is the composition of any of embodiments 27-29, wherein R^{H} is a C₁₁-C₂₁ side chain.

Embodiment 31 is the composition of any of embodiments 1-26, wherein each of the one or more monoglycerides independently comprises a compound of Formula IA-i or Formula

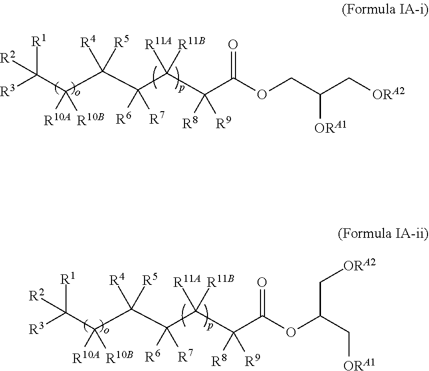

wherein:
   R^{A1} and R^{A2} are each independently selected from H and C₁-C₆ alkyl;
   R¹, R², R², R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17; and
   the sum of o and p is from 0 to 17.

Embodiment 32 is the composition of embodiment 31, wherein R^{A1} and R^{A2} are each H.

Embodiment 33 is the composition of any of embodiments 1-32, wherein each of the one or more salts independently comprises a compound of Formula II:

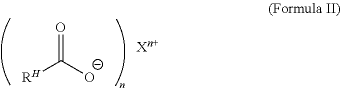

wherein:
   R^{H} is a C₃-C₂₇ side chain; and
   Xⁿ⁺ is a cationic moiety having formal charge n.

Embodiment 34 is the composition of embodiment 33, wherein
Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺; and
each occurrence of R^{D} is selected from H, C₁-C₆ alkyl, C₃-C₆ cycloalkyl, C₃-C₆ heterocycloalkyl, aryl, and heteroaryl, wherein
   each C₁-C₆ alkyl is optionally substituted with 1-3 R^{E} independently selected from C₃-C₆ cycloalkyl, C₃-C₆ heterocycloalkyl, aryl, and heteroaryl; and
   optionally, one or more instances of R^{D} are taken together with the nitrogen atom to which they are attached to form a C₃-C₆ heterocycloalkyl.

Embodiment 35 is the composition of embodiment 33 or embodiment 34, wherein R^{H} is a saturated, unsubstituted side chain.

Embodiment 36 is the composition of any of embodiments 1-32, wherein each of the one or more salts independently comprises a compound of Formula IIA:

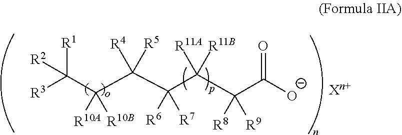

wherein:
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17;
   the sum of o and p is from 0 to 17; and
   Xⁿ⁺ is a cationic moiety having formal charge n.

Embodiment 37 is the composition of embodiment 36, wherein
Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺; and
each occurrence of R^{D} is selected from H, C₁-C₆ alkyl, C₃-C₆ cycloalkyl, C₃-C₆ heterocycloalkyl, aryl, and heteroaryl, wherein
   each C₁-C₆ alkyl is optionally substituted with 1-3 R^{E} independently selected from C₃-C₆ cycloalkyl, C₃-C₆ heterocycloalkyl, aryl, and heteroaryl; and
   optionally, one or more instances of R^{D} are taken together with the nitrogen atom to which they are attached to form a C₃-C₆ heterocycloalkyl.

Embodiment 38 is a mixture comprising:
the composition of any of embodiments 1-37; and
a solvent.

Embodiment 39 is the mixture of embodiment 38, comprising about 30 wt % to about 99.9 wt % of the composition.

Embodiment 40 is the mixture of embodiment 38, comprising about 90 wt % to about 99.5 wt % of the composition.

Embodiment 41 is the mixture of any of embodiments 38-40, wherein the solvent comprises water, methanol, ethanol, isopropanol, butanol, acetone, ethyl acetate, chloroform, acetonitrile, tetrahydrofuran, diethyl ether, methyl tert-butyl ether, or any combination thereof.

Embodiment 42 is a coated agricultural product comprising an agricultural product and a layer disposed on a surface of the agricultural product, wherein the layer comprises the composition of any of embodiments 1-37.

Embodiment 43 is the coated agricultural product of embodiment 42, wherein the layer is disposed on a cuticular surface of the agricultural product.

Embodiment 44 is the coated agricultural product of embodiment 42 or embodiment 43, wherein a thickness of the layer is about 0.1 μm to about 20 μm.

Embodiment 45 is the coated agricultural product of embodiment 42 or embodiment 43, wherein a thickness of the layer is about 0.1 μm to about 10 μm.

Embodiment 46 is a method of coating an agricultural product, the method comprising:
contacting a surface of the agricultural product with a mixture comprising a coating agent and a solvent, wherein the coating agent comprises
   one or more monoglycerides of a C₄-C₂₈ fatty acid;
   one or more salts of a C₄-C₂₈ fatty acid; and
   one or more zwitterions;
wherein a ratio of a total number of moles of the one or more monoglycerides to a total number of moles of the one or more salts and the one or more zwitterions is about 100:1 to about 4:1; and
removing at least a portion of the solvent to form a coating on the surface of the agricultural product.

Embodiment 47 is the method of embodiment 46, wherein the surface is a cuticular surface of the agricultural product.

Embodiment 48 is the method of embodiment 46 or embodiment 47, wherein contacting the surface comprises:
spraying the mixture onto the surface; or
immersing the agricultural product in the mixture.

Embodiment 49 is the method of any of embodiments 46-48, wherein removing at least a portion of the solvent comprises evaporating at least a portion of the solvent.

Embodiment 50 is the method of any of embodiments 46-49, wherein the solvent comprises one or more of water, methanol, ethanol, isopropanol, butanol, acetone, ethyl acetate, chloroform, acetonitrile, tetrahydrofuran, diethyl ether, methyl tert-butyl ether.

Embodiment 51 is the method of any of embodiments 46-50, wherein a concentration of the coating agent in the mixture is about 1 mg/mL to about 200 mg/mL.

Embodiment 52 is the method of any of embodiments 46-50, wherein a concentration of the coating agent in the mixture is about 50 mg/mL to about 200 mg/mL.

Embodiment 53 is the method of any of embodiments 46-52, wherein the coating agent further comprises one or more inorganic salts.

Embodiment 54 is the method of embodiment 53, wherein the one or more inorganic salts comprises sodium chloride, potassium chloride, sodium bromide, potassium bromide, or any mixture thereof.

Embodiment 55 is the method of embodiment 53 or embodiment 54, wherein a concentration of a total amount of the one or more inorganic salts in the mixture is about 5 ppm to about 500 ppm, calculated on a weight basis.

Embodiment 56 is the method of any of embodiments 46-55, wherein:
the one or more monoglycerides are present in a total amount of about 70 wt % to about 99 wt % of the coating agent;
the one or more salts are present in a total amount of about 1 wt % to about 10 wt % of the coating agent; and
the one or more zwitterions are present in a total amount of about 1 wt % to about 10 wt % of the coating agent.

Embodiment 57 is the method of any of embodiments 46-56, wherein:
a ratio of a total number of moles of the one or more monoglycerides to a total number of moles of the one or more salts and the one or more zwitterions is about 100:1: to about 6:1; and
a ratio of a total number of moles of the one or more salts to a total number of moles of the one or more zwitterions is about 10:1 to about 1:10.

Embodiment 58 is the method of any of embodiments 46-57, wherein the one or more monoglycerides, the one or more salts, and the one or more zwitterions make up at least about 80 wt % of the coating agent.

Embodiment 59 is the method of any of embodiments 46-58, wherein the coating agent and the solvent make up at least about 95 wt % of the mixture.

Embodiment 60 is the method of any of embodiments 46-59, wherein the coating agent comprises a lecithin, a hydrolyzed lecithin, or a combination thereof, comprising at least one of the zwitterions.

Embodiment 61 is the method of embodiment 60, wherein the coating agent comprises about 1 wt % to about 10 wt % of the lecithin, the hydrolyzed lecithin, or a combination thereof.

Embodiment 62 is the method of any of embodiments 46-61, wherein at least one of the zwitterions comprises
a positively charged group comprising a quaternary ammonium group or a phosphonium group; and
a negatively charged group comprising a phosphate group, a sulfonate group, or a carboxylate group.

Embodiment 63 is the method of any of embodiments 46-62, wherein at least one of the zwitterions comprises a betaine, a phosphatidylcholine, a lysophosphatidylcholine, a hydroxysultaine, or an amphoacetate salt.

Embodiment 64 is a method of coating an agricultural product, the method comprising:
contacting a surface of the agricultural product with the mixture of any of embodiments 38-41; and
removing at least a portion of the solvent to form a coating on the surface of the agricultural product.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a graph showing viscoelastic properties of certain mixtures described herein.

FIG. 2 is a graph showing respiration production of California avocados coated with certain compositions described herein.

FIG. 3 is a graph showing respiration production of California avocados coated with certain compositions described herein.

### DETAILED DESCRIPTION

The present disclosure relates to compositions including monoglycerides and co-surfactants. In particular, the compositions described herein can be coated onto an agricultural product to provide an improved barrier, e.g., to gas or water. Such coatings can better limit mass loss and/or CO₂ production from an agricultural product as compared to those lacking a co-surfactant. Moreover, solvent mixtures of the compositions described herein can have physical properties better suited for application to an agricultural product, e.g., by spray- or dip-coating.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

The terms “a,” “an,” and “the” are used herein to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the term “about” allows for a degree of variability in a value or range within 10% of a stated value or of a stated limit of a range.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the term “monoglyceride” refers to the condensation product of one glycerol molecule and one fatty acid—that is, a glycerol group attached through an ester linkage to one fatty acid. Monoglycerides can, but need not necessarily be derived from a condensation reaction. For example, monoglycerides can be obtained by an esterification reaction between glycerol and a fatty acid, by transesterification of a triglyceride with glycerol (glycerolysis), etc. Monoglycerides can also be referred to as glyceryl monoalkanoates. Where the glycerol group is attached to the ester linkage at the 1-position (e.g., as in 2,3-dihydroxypropan-1-yl octadecanoate), the monoglyceride can be referred to as a 1-monoglyceride or a 1-glyceryl alkanoate (e.g., as in 1-glyceryl octadecanoate). Where the glycerol group is attached to the ester linkage at the 2-position (e.g., as in 1,3-dihydroxypropan-2-yl hexadecanoate), the monoglyceride can be referred to as a 2-monoglyceride or a 2-glyceryl alkanoate (e.g., as in 2-glyceryl hexadecanoate). The glycerol group of a monoglyceride can be unsubstituted (e.g., as in a 2,3-dihyrdroxpropan-1-yl alkanoate), or can be further substituted with one or more groups other than a fatty acid (e.g., as in a 1,3-dialkoxypropan-2-yl alkanoate).

As used herein, the term “fatty acid” refers to carboxylic acids having an aliphatic side chain. Fatty acids can be naturally or non-naturally occurring, and can include a side chain that is branched or unbranched (e.g., linear), substituted or unsubstituted, and saturated or unsaturated.

As used herein, the term “side chain” refers to the aliphatic portion of a fatty acid, or a portion thereof. Unless otherwise indicated, the side chain of a given fatty acid includes the carbon of the carboxylic acid group. For example, dodecanoic acid can be described as including a linear, saturated C₁₂ side chain, and can also be represented as R^{H}—C(O)OH, where R^{H} is a linear, saturated C₁₁ side chain. Side chains can be present in compounds other than fatty acids, such as, for example, esters or amides, and can, but need not necessarily be derived from a fatty acid. For example, dodecanamide can be described as an amide of a fatty acid, whether or not the compound was in fact derived from dodecanoic acid.

The term “salt,” used in reference to a disclosed compound (e.g., a fatty acid) refers to derivatives of the compound where the parent compound is modified by converting acid or base moieties to their salt form. Examples of such salts include, but are not limited to, mineral or organic acid salts of basic residues such as amine, alkali or organic salts of acidic residues such as carboxylic acids, and the like.

Where certain features of the compounds described herein are disclosed in groups or in ranges, such disclosure includes each and every individual sub-combination of the members of such groups and ranges. For example, the term “C₁-C₆ alkyl” includes (without limitation) methyl, ethyl, C₃ alkyl, C₄ alkyl, C₅ alkyl, and C₆ alkyl.

As used herein, the term “n-membered,” where n is an integer, typically describes the number of ring-forming atoms in a moiety where the number of ring-forming atoms is n. For example, piperidinyl is an example of a 6-membered heterocycloalkyl ring, and 1,2,3,4-tetrahydro-naphthalene is an example of a 10-membered cycloalkyl group.

As used herein, the term “substituted” means that an atom or group of atoms formally replaces hydrogen as a “substituent” attached to another group. “Substituted,” unless otherwise indicated, refers to any level of substitution, e.g., mono-, di-, tri-, tetra- or penta-substitution, where such substitution is permitted. The substituents are independently selected, and substitution may be at any chemically accessible position. Substitution at a given atom is limited by valency. The phrase “optionally substituted” means unsubstituted or substituted. A single divalent substituent, e.g., oxo, can replace two hydrogen atoms.

As used herein, the term “C-Cₘ” indicates a range which includes the endpoints, wherein n and m are integers and indicate the number of carbons. Examples include C₁-C_{4,} C₁-C₆ and the like.

As used herein, the term “alkyl” refers to a saturated hydrocarbon group that may be straight-chained or branched. The term “Cₙ-Cₘ alkyl” refers to an alkyl group having n to m carbon atoms. An alkyl group formally corresponds to an alkane with one C—H bond replaced by the point of attachment of the alkyl group to the remainder of the compound. Examples of alkyl moieties include, but are not limited to, chemical groups such as methyl, ethyl, n-propyl, isopropyl, n-butyl, tent-butyl, isobutyl, sec-butyl; higher homologs such as 2-methyl-1-butyl, n-pentyl, 3-pentyl, n-hexyl, 1,2,2-trimethylpropyl, and the like.

As used herein, the term “alkenyl” refers to a straight-chain or branched hydrocarbon group corresponding to an alkyl group having one or more double carbon-carbon bonds. An alkenyl group formally corresponds to an alkene with one C—H bond replaced by the point of attachment of the alkenyl group to the remainder of the compound. The term “Cₙ-Cₘ alkenyl” refers to an alkenyl group having n to m carbons. Example alkenyl groups include, but are not limited to, ethenyl, n-propenyl, isopropenyl, n-butenyl, sec-butenyl and the like.

As used herein, the term “alkoxy” refers to a group of formula —O-alkyl, wherein the alkyl group is as defined above. The term “Cₙ-Cₘ alkoxy” refers to an alkoxy group, the alkyl group of which has n to m carbons. Example alkoxy groups include methoxy, ethoxy, propoxy (e.g., n-propoxy and isopropoxy), t-butoxy and the like.

As used herein, the term “cycloalkyl” refers to a non-aromatic hydrocarbon ring system (monocyclic, bicyclic, or polycyclic), including cyclized alkyl and alkenyl groups. The term “Cₙ-Cₘ cycloalkyl” refers to a cycloalkyl that has n to m ring member carbon atoms. Cycloalkyl groups can include fused, bridged, and/or spiro bicyclic or polycyclic ring systems. Examples of cycloalkyl groups include, but are not limited to, cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcarnyl, bicyclo[1.1.0]butanyl, bicyclo[1.1.1]pentanyl, bicyclo[2.1.0]pentanyl, bicyclo[2.2.0]hexanyl, bicyclo[3.1.0]hexanyl, bicyclo[3.2.0]heptanyl, and bicyclo[3.3.0]-octanyl, bicyclo[2.1.1]hexanyl, bicyclo[2.2.1]heptanyl and bicyclo[1.1.1]pentanyl, and the like.

As used herein, the term “heterocycloalkyl” refers to a non-aromatic ring system (monocyclic, bicyclic, or polycyclic), which may optionally contain one or more alkenylene groups as part of the ring structure, which has at least one heteroatom ring member independently selected from nitrogen, sulfur, oxygen, and phosphorus. The term “n- to m-membered ring heterocycloalkyl” refers to a heterocycloalkyl that has n to m ring-forming atoms. Ring-forming carbon atoms and heteroatoms of a heterocycloalkyl group can be optionally oxidized to form an oxo or sulfido group or other oxidized linkage (e.g., C(O), S(O), C(S), S(O)₂, N-oxide, etc.) or a nitrogen atom can be quaternized. The heterocycloalkyl group can be attached through a ring-forming carbon atom or a ring-forming heteroatom. Heterocycloalkyl groups can include double bonds, for example, up to 3 double bonds. Examples of heterocycloalkyl groups include, but are not limited to, azetidinyl, dihydrofuranyl, dihydrothiophenyl, tetrahydrothiophenyl, tetrahydrofuranyl, tetrahydrotriazinyl, tetrahydropyrazolyl, tetrahydrooxazinyl, tetrahydropyrimidinyl, octahydrobenzofuranyl, octahydrobenzimidazolyl, octahydrobenzothiazolyl, imidazolidinyl, pyrrolidinyl, piperidinyl, piperazinyl, oxazolidinyl, thiazolidinyl, pyrazolidinyl, thiomorpholinyl, tetrahydropyranyl, tetrahydrothiazinyl, tetrahydrothiadiazinyl, tetrahydro-oxazolyl, morpholinyl, oxetanyl, dioxetanyl, dioxolanyl, dioxanyl, oxapanyl, dioxapanyl, oxacanyl, dioxacanyl, tetrahydrodiazinyl, oxazinyl, oxathiazinyl, quinuclidinyl, chromanyl, isochromanyl, dihydrobenzodioxinyl, benzodioxolyl, benzoxazinyl, indolinyl, dihydrobenzofuranyl, tetrahydroquinolyl, isochromyl, dihydro-1H-isoindolyl, 2-azabicyclo[2.2.1]heptanonyl, 3-azabicyclo[3.1.0]hexanyl, 3-azabicyclo[4.1.0]heptanyl, and the like. Further examples of heterocycloalkyl groups include tetrahydrofuran-2-yl, tetrahydrofuran-3-yl, imidazolidin-1-yl, imidazolidin-2-yl, imidazolidin-4-yl, pyrrolidin-1-yl, pyrrolidin-2-yl, pyrrolidin-3-yl, piperidin-1-yl, piperidin-2-yl, piperidin-3-yl, piperidin-4-yl, piperazin-1-yl, piperazin-2-yl, 1,3-oxazolidin-3-yl, 1,4-oxazepan-1-yl, isothiazolidinyl, 1,3-thiazolidin-3-yl, 1,2-pyrazolidin-2-yl, 1,2-tetrahydrothiazin-2-yl, 1,3-thiazinan-3-yl, 1,2-tetrahydrodiazin-2-yl, 1,3-tetrahydrodiazin-1-yl, 1,4-oxazin-4-yl, oxazolidinonyl, 2-oxo-piperidinyl (e.g., 2-oxo-piperidin-1-yl), and the like.

### Compositions

Provided herein are compositions including one or more monoglycerides of a C₄-C₂₈ fatty acid, one or more salts of a C₄-C₂₈ fatty acid, and one or more zwitterions. As described herein, zwitterionic compounds can act as co-surfactants (e.g., with fatty acid salts) to reduce the difference in surface energy between a suspension, colloid, or solution thereof and a solid surface on which the suspension, colloid, or solution is disposed.

In some embodiments, the one or more monoglycerides are present in a total amount of about 40 wt % to about 99 wt % of the composition, for example, about 40 wt % to about 98 wt %, about 40 wt % to about 96 wt %, about 70 wt % to about 99 wt %, about 70 wt % to about 98 wt %, about 70 wt % to about 96 wt %, about 80 wt % to about 99 wt %, about 80 wt % to about 98 wt %, or about 80 wt % to about 96 wt % of the composition. In some embodiments, the one or more salts are present in a total amount of about 0.1 wt % to about 20 wt % of the composition, for example, about 0.1 wt % to about 15 wt %, about 0.1 wt % to about 10 wt %, about 1 wt % to about 20 wt %, about 1 wt % to about 15 wt %, about 1 wt % to about 10 wt %, about 2 wt % to about 20 wt %, about 2 wt % to about 15 wt %, or about 2 wt % to about 10 wt % of the composition. In some embodiments, the one or more zwitterions are present in a total amount of about 0.1 wt % to about 20 wt % of the composition, for example, about 0.1 wt % to about 15 wt %, about 0.1 wt % to about 10 wt %, about 1 wt % to about 20 wt %, about 1 wt % to about 15 wt %, about 1 wt % to about 10 wt %, about 2 wt % to about 20 wt %, about 2 wt % to about 15 wt %, or about 2 wt % to about 10 wt % of the composition.

In some embodiments, the composition further includes an inorganic salt. In some embodiments, the composition includes up to about 1 wt % of an inorganic salt, for example, about 0.01 wt % to about 1 wt %, about 0.01 wt % to about 0.75 wt %, about 0.01 wt % to about 0.5 wt %, about 0.05 wt % to about 1 wt %, about 0.05 wt % to about 0.75 wt %, about 0.05 wt % to about 0.5 wt %, about 0.1 wt % to about 1 wt %, about 0.1 wt % to about 0.75 wt %, or about 0.1 wt % to about 0.5 wt % of an inorganic salt. In some embodiments, the inorganic salt includes sodium chloride, potassium chloride, sodium bromide, potassium bromide, or any combination thereof. In some embodiments, the inorganic salt includes sodium chloride.

In some embodiments, a ratio of a total number of moles of the one or more monoglycerides to a total number of moles of the one or more salts and the one or more zwitterions is amount 100:1 to about 4:1, for example, about 100:1 to about 6:1, about 100:1 to about 8:1, about 75:1 to about 4:1, about 75:1 to about 6:1, about 75:1 to about 4:1, about 50:1 to about 4:1, about 50:1 to about 6:1, or about 50:1 to about 8:1.

In some embodiments, a ratio of a total number of moles of the one or more salts to a total number of moles of the one or more zwitterions is about 10:1 to about 1:10, for example, about 10:1 to about 1:8, about 10:1 to about 1:6, about 5:1 to about 1:10, about 5:1 to about 1:8, about 5:1 to about 1:6, about 1:1 to about 1:10, about 1:1 to about 1:8, or about 1:1 to about 1:6.

In some embodiments, the one or more monoglycerides, the one or more salts, and the one or more zwitterions make up at least about 80 wt % of the composition, for example, at least about 85 wt %, at least about 90 wt %, at least about 95 wt %, at least about 97.5 wt %, at least about 98 wt %, or at least about 99 wt % of the composition.

### Monoglycerides of a C₄-C₂₈ Fatty Acid

The compositions described herein include one or more monoglycerides of a C₄-C₂₈ fatty acid. In some embodiments, the composition includes one monoglyceride of a C₄-C₂₈ fatty acid. In some embodiments, the composition includes two, three, or more monoglycerides of a C₄-C₂₈ fatty acid, for example, two monoglycerides of a C₄-C₂₈ fatty acid. In some embodiments, the monoglycerides include one or more monoglycerides of a naturally occurring fatty acid.

The monoglycerides can include one or more 1-monoglycerides, one or more 2-monoglycerides, or a mixture thereof. In some embodiments, the monoglycerides include one or more 2,3-dihydroxypropan-1-yl esters of a fatty acid, one or more 1,3-dihydroxypropan-2-yl esters of a fatty acid, or a mixture thereof. In some embodiments, 1-monoglycerides make up at least about 50 wt %, at least about 60 wt %, at least about 70 wt %, at least about 75 wt %, at least about 80 wt %, at least about 85 wt %, at least about 90 wt %, or at least about 95 wt %, or about 100 wt % of the monoglycerides present in the composition. In some embodiments, 1-monoglycerides make up about 70 wt % to about 100 wt %, about 70 wt % to about 95 wt %, about 70 wt % to about 90 wt %, about 75 wt % to about 100 wt %, about 75 wt % to about 95 wt %, about 75 wt % to about 90 wt %, about 80 wt % to about 100 wt %, about 80 wt % to about 95 wt %, or about 80 wt % to about 90 wt % of the monoglycerides present in the composition.

In some embodiments, the monoglycerides include one or more monoglycerides of a C₆-C₂₈ fatty acid, a C₈-C₂₈ fatty acid, a C₄-C₂₄ fatty acid, a C₆-C₂₄ fatty acid, a C₁₂-C₂₄ fatty acid, a C₄-C₂₂ fatty acid, a C₆-C₂₂ fatty acid, or a C₁₂-C₂₂ fatty acid. In some embodiments, one or more of the monoglycerides include an unsubstituted side chain, for example, an unsubstituted C₁₂-C₂₂ side chain. In some embodiments, one or more of the monoglycerides include a linear side chain, for example, a linear C₁₂-C₂₂ side chain. In some embodiments, one or more of the monoglycerides include a saturated side chain, for example, a saturated C₁₂-C₂₂ side chain.

In some embodiments, the monoglycerides include one or more compounds of Formula I-i:

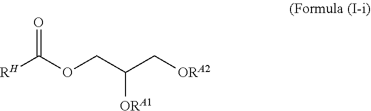

wherein:
   R^{A1} and R^{A2} are each independently selected from H and C₁-C₆ alkyl; and
   R^{H} is a C₃-C₂₇ side chain.

In some embodiments, the monoglycerides include one or more compounds of Formula I-ii:

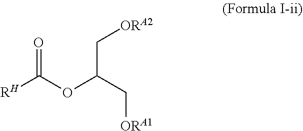

wherein:
   R^{A1} and R^{A2} are each independently selected from H and C₁-C₆ alkyl; and
   R^{H} is a C₃-C₂₇ side chain.

In some embodiments, each of the one or more monoglycerides independently includes a compound of Formula I-i or Formula I-ii. In some embodiments of Formula I-i or Formula I-ii, R^{A1} and R^{A2} are each H. In some embodiments of Formula I-i or Formula I-ii, R^{H} is a saturated side chain. In some embodiments of Formula I-i or Formula I-ii, R^{H} is an unsubstituted side chain. In some embodiments of Formula I-i or Formula I-ii, R^{H} is a linear side chain. In some embodiments of Formula I-i or Formula I-ii, R^{H} is a C₅-C₁₇ side chain. In some embodiments of Formula I-i or Formula I-ii, R^{H} is a C₁₁-C₂₁ side chain.

In some embodiments, the monoglycerides include one or more compounds of Formula IA-i:

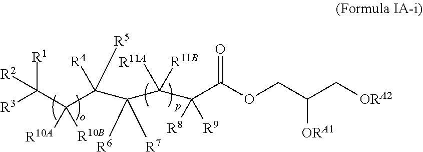

wherein:
   R^{A1} and R^{A2} are each independently selected from H and C₁-C₆ alkyl;
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17; and
   the sum of o and p is from 0 to 17.

In some embodiments, the monoglycerides include one or more compounds of Formula IA-ii:

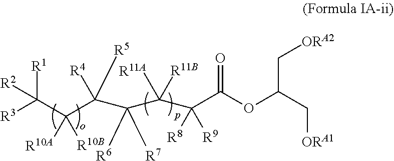

wherein:
   R^{A1} and R^{A2} are each independently selected from H and C₁-C₆ alkyl;
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17; and
   the sum of o and p is from 0 to 17.

In some embodiments, each of the one or more monoglycerides independently includes a compound of Formula IA-i or Formula IA-ii. In some embodiments of Formula IA-i or Formula IA-ii, R^{A1} and R^{A2} are each H. In some embodiments of Formula IA-i or Formula IA-ii, each of R¹, R², R³, R⁴, R⁵, R⁶, R⁷, R⁸, and R⁹, and each occurrence of R^{10A}, R^{10B}, R^{11A}, and R^{11B} are independently selected from H and OH. In some embodiments of Formula IA-i or Formula IA-ii, any two of R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula IA-i or Formula IA-ii, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IA-i or Formula IA-ii, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form an oxirane. In some embodiments of Formula IA-i or Formula IA-ii, two, one, or none of R¹, R², R³, R⁴, R⁵, R⁶, R⁷, R⁸, and R⁹, and each occurrence of R^{10A}, R^{10B}, R^{11A}, and R^{11B} are OH.

In some embodiments of Formula IA-i or Formula IA-ii, the sum of o and p is from 0 to 13, from 0 to 11, from 0 to 9, from 0 to 7, from 5 to 17, from 5 to 13, from 5 to 11, from 5 to 9, from 5 to 7, from 7 to 17, from 7 to 13, from 7 to 11, from 7 to 9, from 9 to 17, from 9 to 13, from 9 to 11, from 11 to 17, or from 11 to 13.

In some embodiments, the monoglycerides include one or more 1-monoglycerides or 2-monoglycerides, for example, 2,3-dihydroxypropan-1-yl esters or 1,3-dihydroxypropan-2-yl esters, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid or docosanoic acid, 9-hydroxyhexadecanoic acid, 10-hydroxyhexadecanoic acid, 9,10-dihydroxyhexadecanoic acid, 16-hydroxyhexadecanoic acid, 9,16-dihydroxyhexadecanoic acid, 10,16-dihydroxyhexadecanoic acid, 9,10,16-trihydroxyhexadecanoic acid, 9,10-epoxyhexadecanoic acid, (9Z)-hexadec-9-enoic acid, (9E)-hexadec-9-enoic acid, 9,10-epoxy-16-hydroxyhexadecanoic acid, 16-hydroxy-(9Z)-hexadec-9-enoic acid, 16-hydroxy-(9E)-hexadec-9-enoic acid, 9-hydroxyoctadecanoic acid, 10-hydroxyoctadecanoic acid, 9,10-dihydroxyoctadecanoic acid, 18-hydroxyoctadecanoic acid, 9,18-dihydroxyoctadecanoic acid, 10,18-dihydroxyoctadecanoic acid, 9,10,18-trihydroxyoctadecanoic acid, 9,10-epoxyoctadecanoic acid, (9Z)-octadec-9-enoic acid, (9E)-octadec-9-enoic acid, 18-hydroxy-9,10-dihydroxyoctadecanoic acid, 18-hydroxy-(9Z)-octadec-9-enoic acid, 18-hydroxy-(9E)-octadec-9-enoic acid, (13Z)-docos-13-enoic acid, or (13E)-docos-13-enoic acid.

### Salts of a C₄-C₂₈ Fatty Acid

The compositions described herein include one or more salts of a C₄-C₂₈ fatty acid. In some embodiments, the composition includes one salt of a C₄-C₂₈ fatty acid. In some embodiments, the composition includes two, three, or more salts of a C₄-C₂₈ fatty acid, for example, two salts of a C₄-C₂₈ fatty acid. In some embodiments, the salts include one or more salts of a naturally occurring fatty acid.

In some embodiments, the salts include one or more salts of a C₆-C₂₈ fatty acid, a C₈-C₂₈ fatty acid, a C₄-C₂₄ fatty acid, a C₆-C₂₄ fatty acid, a C₁₂-C₂₄ fatty acid, a C₄-C₂₂ fatty acid, a C₆-C₂₂ fatty acid, or a C₁₂-C₂₂ fatty acid. In some embodiments, one or more of the salts include an unsubstituted side chain, for example, an unsubstituted C₁₂-C₂₂ side chain. In some embodiments, one or more of the salts include a linear side chain, for example, a linear C₁₂-C₂₂ side chain. In some embodiments, one or more of the salts include a saturated side chain, for example, a saturated C₁₂-C₂₂ side chain.

In some embodiments, the salts include one or more compounds of Formula II

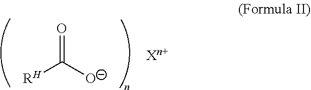

wherein:
   R^{H} is a C₃-C₂₇ side chain; and
   Xⁿ⁺ is a cationic moiety having formal charge n.

In some embodiments, each of the one or more salts independently includes a compound of Formula II. In some embodiments of Formula II, Xⁿ⁺ is selected from Li⁺, Na⁺, K⁺, Cs⁺ Ag⁺, Ca²⁺, Mg²⁺, Zn²⁺, Cu²⁺, and (R^{D})₄N⁺, where each occurrence of R^{D} is selected from H, C₁-C₆ alkyl, C₃-C₆ cycloalkyl, C₃-C₆ heterocycloalkyl, aryl, and heteroaryl, and where each C₁-C₆ alkyl is optionally substituted with 1-3 R^{E} independently selected from C₃-C₆ cycloalkyl, C₃-C₆ heterocycloalkyl, aryl, and heteroaryl. In some embodiments, Xⁿ⁺ is (R^{D})₄N⁺, and one or more instances of R^{D} are taken together with the nitrogen atom to which they are attached to form a C₃-C₆ heterocycloalkyl. In some embodiments of Formula II, Xⁿ⁺ is selected from Na⁺, K⁺, Ca⁺, Mg²⁺, and Zn²⁺. In some embodiments of Formula II, R^{H} is a saturated side chain. In some embodiments of Formula II, R^{H} is an unsubstituted side chain. In some embodiments of Formula II, R^{H} is a linear side chain. In some embodiments of Formula II, R^{H} is a C₅-C₁₇ side chain. In some embodiments of Formula II, R^{H} is a C₁₁-C₂₁ side chain.

In some embodiments, the salts include one or more compounds of Formula IIA

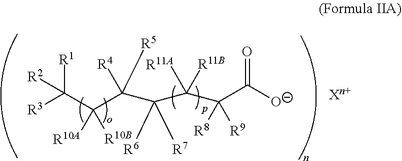

wherein:
   R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
   each occurrence of R^{10A}, R^{10B}, R^{11A}, and R^{11B} is independently selected from H, OH, C₁-C₆ alkyl, C₂-C₆ alkenyl, and C₁-C₆ alkoxy;
   any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
   o is an integer from 0 to 17;
   p is an integer from 0 to 17;
   the sum of o and p is from 0 to 17; and
   Xⁿ⁺ is a cationic moiety having formal charge n.

In some embodiments, each of the one or more salts independently includes a compound of Formula IIA. In some embodiments of Formula IIA, Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺, where each occurrence of R^{D} is selected from H, C₁-C₆ alkyl, C₃-C₆ cycloalkyl, C₃-C₆ heterocycloalkyl, aryl, and heteroaryl, and where each C₁-C₆ alkyl is optionally substituted with 1-3 R^{E} independently selected from C₃-C₆ cycloalkyl, C₃-C₆ heterocycloalkyl, aryl, and heteroaryl. In some embodiments, Xⁿ⁺ is (R^{D})₄N⁺, and one or more instances of R^{D} are taken together with the nitrogen atom to which they are attached to form a C₃-C₆ heterocycloalkyl. In some embodiments of Formula II, Xⁿ⁺ is selected from Na⁺, K⁺, Ca²⁺, Mg²⁺, and Zn²⁺.

In some embodiments of Formula IIA, each of R¹, R², R³, R⁴, R⁵, R⁶, R⁷, R⁸, and R⁹, and each occurrence of R^{10A}, R^{10B}, R^{11A}, and R^{11B} are independently selected from H and OH. In some embodiments of Formula IIA, any two of R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula IIA, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IIA, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form an oxirane. In some embodiments of Formula IIA, two, one, or none of R¹, R², R³, R⁴, R⁵, R⁶, R⁷, R⁸, and R⁹, and each occurrence of R^{10A}, R^{10B}, R^{11A}, and R^{11B} are OH.

In some embodiments of Formula IIA, the sum of o and p is from 0 to 13, from 0 to 11, from 0 to 9, from 0 to 7, from 5 to 17, from 5 to 13, from 5 to 11, from 5 to 9, from 5 to 7, from 7 to 17, from 7 to 13, from 7 to 11, from 7 to 9, from 9 to 17, from 9 to 13, from 9 to 11, from 11 to 17, or from 11 to 13.

In some embodiments, the salts include one or more salts, for example, sodium, potassium, silver, calcium, magnesium or zinc salts, of a saturated, linear, unsubstituted fatty acid. In some embodiments, the salts include one or more salts, for example, sodium, potassium, silver, calcium, magnesium or zinc salts, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid or docosanoic acid, 18-hydroxy-9,10-dihydroxyoctadecanoic acid, 18-hydroxy-(9Z)-octadec-9-enoic acid, or 18-hydroxy-(9E)-octadec-9-enoic acid.

### Zwitterions

The compositions described herein include one or more zwitterions. In some embodiments, the composition includes one zwitterion. In some embodiments, the composition includes two, three, or more zwitterions, for example, two zwitterions. In some embodiments, one or more of the zwitterions cannot convert to a neutral, uncharged form. For example, in some embodiments, each of the zwitterions cannot convert to a neutral, uncharged form.

In some embodiments, one or more of the zwitterions includes a positively charged group including a quaternary ammonium group or a phosphonium group. In some embodiments, one or more of the zwitterions includes a negatively charged group including a phosphate group, a sulfonate group, or a carboxylate group. In some embodiments, one or more of the zwitterions includes a quaternary ammonium group and a negatively charged group including a phosphate group, a sulfonate group, or a carboxylate group.

In some embodiments, the zwitterions include a betaine, a phosphatidylcholine, a lysophosphatidylcholine, a phosphatidylserine, a lysophosphatidylserine, a hydroxylsultaine, an amphoacetate salt, or any combination thereof. In some embodiments, betaines, phosphatidylcholines, lysophosphatidylcholines, phosphatidylserines, lysophosphatidylserines, hydroxysultaines, and amphoacetate salts make up at least about 50 wt %, at least about 60 wt %, at least about 70 wt %, at least about 75 wt %, at least about 80 wt %, at least about 85 wt %, at least about 90 wt %, or at least about 95 wt % of the zwitterions present in the composition.

In some embodiments, the composition includes a lecithin or a hydrolyzed lecithin including one or more zwitterions. In some embodiments, the composition includes a lecithin or a hydrolyzed lecithin (lysolecithin) including one or more zwitterionic glycerophospholipids such as, for example, phosphatidylcholine or lysophosphatidylcholine. In some embodiments, the lecithin or hydrolyzed lecithin contains at least about 10 wt %, or at least about 15 wt %, or at least about 20 wt % of zwitterions. In some embodiments, the composition includes lecithin, and the lecithin includes about 15 wt % to about 35 wt % of zwitterions including, for example, phosphatidylcholine or phosphatidylserine. In some embodiments, the composition includes lysolecithin, and the lysolecithin includes about 15 wt % to about 35 wt % of zwitterions including, for example, lysophosphatidylcholine or lysophosphatidylserine.

In some embodiments, the zwitterions include one or more compounds of Formula III-i:

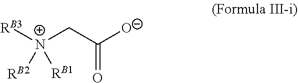

wherein:
   R^{B1}, R^{B2}, and R^{B3} are each independently selected from C₁-C₂₂ alkyl and (C₁-C₆ alkyl)-NR^{B4}C(O)RH;
   each occurrence of R^{B4} is independently H or C₁-C₆ alkyl; and
   each occurrence of R^{H} is independently a C₃-C₂₁ side chain.

In some embodiments, the zwitterions include one or more compounds of Formula III-ii:

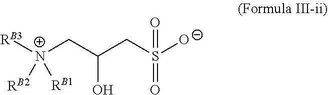

wherein:
   R^{B1}, R^{B2}, and R^{B3} are each independently selected from C₁-C₂₂ alkyl and (C₁-C₆ alkyl)-NR^{B4}C(O)R^{H};
   each occurrence of R^{B4} is independently H or C₁-C₆ alkyl; and
   each occurrence of R^{H} is independently a C₃-C₂₁ side chain.

In some embodiments of Formula III-i or Formula III-ii, R^{B1} and R^{B2} are each C₁ alkyl. In some embodiments of Formula III-i or Formula III-ii, R^{B3} is C₁-C₆ alkyl. In some embodiments of Formula III-i or Formula III-ii, R^{B3} is C₁₀-C₂₀ alkyl. In some embodiments of Formula III-i or Formula III-ii, R^{B3} is (C₁-C₆alkyl)-NR^{B4}C(O)RH, and R^{B4} is H. In some embodiments of Formula III-i or Formula III-ii, R^{H} is a C₆-C₂₁ side chain.

In some embodiments, the zwitterions include one or more compounds of Formula IIIA-i:

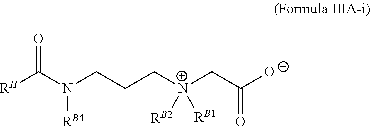

wherein:
   R^{B1} and R^{B2} are each independently selected from C₁-C₆ alkyl;
   R^{B4} is H or C₁-C₆ alkyl; and
   R^{H} is a C₃-C₂₁ side chain.

In some embodiments, the zwitterions include one or more compounds of Formula IIIA-ii:

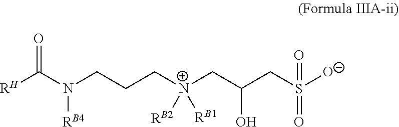

wherein:
   R^{B1} and R^{B2} are each independently selected from C₁-C₆ alkyl;
   R^{B4} is H or C₁-C₆ alkyl; and
   R^{H} is a C₃-C₂₁ side chain.

In some embodiments of Formula IIIA-i or Formula IIIA-ii, R^{B1} and R^{B2} are each C₁ alkyl. In some embodiments of Formula IIIA-i or Formula IIIA-ii, R^{B4} is H. In some embodiments of Formula IIIA-i or Formula IIIA-ii, R^{H} is a C₆-C₂₁ side chain.

In some embodiments, the zwitterions include one or more compounds of Formula IV:

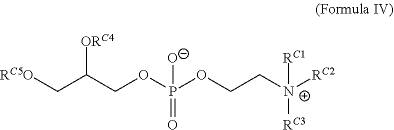

wherein:
   R^{C1}, C^{C2}, and R^{C3} are each independently selected from C₁-C₆ alkyl;
   R^{C4} and R^{C5} are each independently selected from H and C(O)R^{H};
   each R^{H} is independently a C₃-C₂₁ side chain; and
   at least one of R^{C4} and R^{C5} is not H.

In some embodiments of Formula IV, R^{C1}, R^{C2}, and R^{C3} are each C₁ alkyl. In some embodiments, R^{C4} is H and R^{C5} is C(O)R^{H}. In some embodiments, each occurrence of R^{H} is independently a C₆-C₂₁ side chain.

In some embodiments, compounds of Formula III-i, Formula III-ii, Formula IIIA-i, Formula IIIA-ii, and Formula IV make up at least about 50 wt %, at least about 60 wt %, at least about 70 wt %, at least about 75 wt %, at least about 80 wt %, at least about 85 wt %, at least about 90 wt %, or at least about 95 wt % of the zwitterions present in the composition.

### Additional Components

The compositions described herein can include one or more additional components, for example, components that are non-toxic and safe for consumption by humans and/or animals. For example, the composition can include direct or indirect food additives or food-contact substances approved by the U.S. Food and Drug Administration (FDA), components satisfying FDA regulatory requirements to be used as a food additive or food contact substance, or components generally recognized as safe (GRAS) by the FDA.

In some embodiments, the compositions described herein further include one or more fatty acids, for example, C₄-C₂₂ fatty acids, or esters thereof, for example, C₁-C₆ alkyl esters thereof. In some embodiments, the composition includes less than about 10 wt %, for example, less than about 5 wt %, less than about 2 wt %, less than about 1 wt %, or is free from one or more of triglycerides, diglycerides, acetylated monoglycerides, lactlyated monoglycerides, succinylated monoglycerides, sterols, bile acids, proteins, polysaccharides, phenols, lignans, aromatic acids, terpenoids, flavonoids, carotenoids, alkaloids, alcohols, alkanes, aldehydes, and any salts thereof.

### Mixtures

Also provided herein are mixtures including a composition described herein and a solvent. In some embodiments, the mixture includes a dispersion of a composition described herein in a solvent. In some embodiments, the solvent includes water, methanol, ethanol, isopropanol, butanol, acetone, ethyl acetate, chloroform, acetonitrile, tetrahydrofuran, diethyl ether, methyl tert-butyl ether, or any combination thereof. In some embodiments, the solvent includes water, ethanol, or a combination thereof.

In some embodiments, the mixture includes about 30 wt % to about 99.9 wt %, about 30 wt % to about 99.5 wt %, about 30 wt % to about 99 wt %, about 50 wt % to about 99.9 wt %, about 50 wt % to about 99.5 wt %, about 50 wt % to about 99 wt %, about 90 wt % to about 99.9 wt %, about 90 wt % to about 99.5 wt %, or about 90 wt % to about 99 wt % of solvent.

In some embodiments, the concentration of the composition in the mixture is about 1 mg/mL to about 200 mg/mL, about 1 mg/mL to about 150 mg/mL, about 1 mg/mL to about 125 mg/mL, about 1 mg/mL to about 100 mg/mL, about 25 mg/mL to about 200 mg/mL, about 25 mg/mL to about 150 mg/mL, about 25 mg/mL to about 125 mg/mL, about 25 mg/mL to about 100 mg/mL, about 50 mg/mL to about 200 mg/mL, about 50 mg/mL to about 150 mg/mL, about 50 mg/mL to about 125 mg/mL, or about 50 mg/mL to about 100 mg/mL.

In some embodiments, the composition includes an inorganic salt as described herein, and the inorganic salt is present in the mixture in a concentration of about 1 ppm to about 1,000 ppm, about 1 ppm to about 500 ppm, about 1 ppm to about 250, about 25 ppm to about 1,000 ppm, about 25 ppm to about 500 ppm, about 25 ppm to about 250 ppm, about 50 ppm to about 1,000 ppm, about 50 ppm to about 500 ppm, about 50 ppm to about 250 ppm.

### Coatings

Also provided herein are coated agricultural products including an agricultural product and a layer formed from a composition described herein, disposed on a surface of the agricultural product. In some embodiments, the agricultural product is an edible agricultural product including, for example, fruits, vegetables, edible seeds and nuts, herbs, spices, produce, meat, eggs, dairy products, seafood, grains, or any other consumable item. In other embodiments, the agricultural product is an inedible agricultural product including, for example, inedible flowers, seeds, shoots, stems, leaves, whole plants, and the like. In some embodiments, the layer is disposed on an exterior surface (e.g., a cuticular surface) of the agricultural product.

In some embodiments, the layer has a thickness of about 0.1 μm to about 20 μm, for example, about 0.1 μm to about 15 μm, about 0.1 μm to about 10 μm, about 0.5 μm to about 20 μm, about 0.5 μm to about 15 μm, about 0.5 μm to about 10 μm, about 1 μm to about 20 μm, about 1 μm to about 15 μm, or about 1 μm to about 10 μm.

### Coating Methods

Also provided herein are methods for coating an agricultural product, the methods including contacting a surface of the agricultural product with a mixture including a coating agent and a solvent, and removing at least a portion of the solvent to form a coating on the surface of the agricultural product. The coating agent includes one or more monoglycerides of a C₄-C₂₈ fatty acid, one or more salts of a C₄-C₂₈ fatty acid, and one or more zwitterions. In some embodiments, the coating agent is a composition described herein. For example, in some embodiments, a ratio of a total number of moles of the one or more monoglycerides to a total number of moles of the one or more salts and the one or more zwitterions is about 100:1 to about 4:1. In some embodiments, the coating agent includes one or more monoglycerides of a C₄-C₂₈ fatty acid, present in a total amount of about 40 wt % to about 99 wt % of the coating agent, one or more salts of a C₄-C₂₈ fatty acid, present in a total amount of 0.1 wt % to about 20 wt % of the composition, and one or more zwitterions, present in a total amount of 0.1 wt % to about 20 wt % of the coating agent.

In some embodiments of the coating method, the agricultural product is an edible agricultural product including, for example, fruits, vegetables, edible seeds and nuts, herbs, spices, produce, meat, eggs, dairy products, seafood, grains, or any other consumable item. In other embodiments of the coating method, the agricultural product is an inedible agricultural product including, for example, inedible flowers, seeds, shoots, stems, leaves, whole plants, and the like. In some embodiments, the method includes contacting an exterior surface (e.g., a cuticular surface) of the agricultural product with the coating agent-containing mixture.

In some embodiments of the coating method, contacting the surface of the agricultural product includes spraying the mixture onto the surface of the agricultural product. The mixture can be sprayed, for example, from a commercially available sprayer. In some embodiments, the mixture is aerosol-sprayed onto the surface of the agricultural product. In some embodiments of the coating method, contacting the surface of the agricultural product includes immersing the agricultural product in the mixture. In other embodiments of the coating method, the mixture can be brushed, dripped, drop-cast, rolled, dabbed, or poured on the surface of the agricultural product.

In some embodiments of the coating method, removing at least a portion of the solvent includes evaporating at least a portion of solvent. In some embodiments, the evaporation can be passive. In other embodiments, the evaporation can be active, for example, as in convective drying. In some embodiments of the coating method, the solvent includes water, methanol, ethanol, isopropanol, butanol, acetone, ethyl acetate, chloroform, acetonitrile, tetrahydrofuran, diethyl ether, methyl tert-butyl ether, or any combination thereof. In some embodiments of the coating method, the solvent includes water, ethanol, or a combination thereof.

In some embodiments of the coating method, the concentration of the coating agent in the mixture is about 1 mg/mL to about 200 mg/mL, about 1 mg/mL to about 150 mg/mL, about 1 mg/mL to about 125 mg/mL, about 1 mg/mL to about 100 mg/mL, about 25 mg/mL to about 200 mg/mL, about 25 mg/mL to about 150 mg/mL, about 25 mg/mL to about 125 mg/mL, about 25 mg/mL to about 100 mg/mL, about 50 mg/mL to about 200 mg/mL, about 50 mg/mL to about 150 mg/mL, about 50 mg/mL to about 125 mg/mL, or about 50 mg/mL to about 100 mg/mL.

In some embodiments of the coating method, the coating agent includes an inorganic salt as described herein, and the inorganic salt is present in the mixture in a concentration of about 1 ppm to about 1,000 ppm, about 1 ppm to about 500 ppm, about 1 ppm to about 250, about 25 ppm to about 1,000 ppm, about 25 ppm to about 500 ppm, about 25 ppm to about 250 ppm, about 50 ppm to about 1,000 ppm, about 50 ppm to about 500 ppm, about 50 ppm to about 250 ppm.

In some embodiments of the coating method, the one or more monoglycerides are present in a total amount of about 70 wt % to about 99 wt %, or about 80 wt % to about 98 wt % of the coating agent, the one or more salts are present in a total amount of about 1 wt % to about 10 wt %, or about 2 wt % to about 10 wt % of the coating agent, and the one or more zwitterions are present in a total amount of about 1 wt % to about 10 wt % of the coating agent. In some embodiments of the coating method, the ratio of the total number of moles of the one or more monoglycerides to the total number of moles of the one or more salts and the one or more zwitterions is about 100:1 to about 4:1, about 100:1 to about 6:1, or about 50:1 to about 8:1, and the ratio of a total number of moles of the one or more salts to a total number of moles of the one or more zwitterions is about 10:1 to about 1:10, or about 1:1 to about 1:10. In some embodiments, the monoglycerides include a compound of Formula I-i, Formula I-ii, Formula IA-i, or Formula IA-ii described herein. In some embodiments, the salts include a compound of Formula II or Formula IIA described herein. In some embodiments, the zwitterions include a compound of Formula III-i, Formula III-ii, Formula IIIA-i, Formula IIIA-ii, or Formula IV described herein.

In some embodiments of the coating method, the one or more monoglycerides, the one or more salts, and the one or more zwitterions make up at least about 80 wt % of the coating agent, for example, at least about 85 wt %, at least about 90 wt %, at least about 95 wt %, at least about 97.5 wt %, at least about 98 wt %, or at least about 99 wt % of the coating agent. In some embodiments, the coating agent and the solvent make up at least about 95 wt %, for example, at least about 97.5 wt %, at least about 98 wt %, at least about 99 wt %, at least about 99.5 wt %, or at least about 99.9 wt % of the mixture.

In some embodiments of the coating method, the coating agent includes a lecithin or a hydrolyzed lecithin, the lecithin or the hydrolyzed lecithin including at least one of the zwitterions. For example, in some embodiments of the coating method, the coating agent includes about 1 wt % to about 10 wt %, about 1 wt % to about 8 wt %, about 1 wt % to about 6 wt %, about 2 wt % to about 10 wt %, about 2 wt % to about 8 wt %, about 2 wt % to about 6 wt %, about 4 wt % to about 10 wt %, about 4 wt % to about 8 wt %, or about 4 wt % to about 6 wt % of a lecithin, a hydrolyzed lecithin, or a combination thereof. In some embodiments of the coating method, at least one of the zwitterions includes a positively charged group including a quaternary ammonium group or a phosphonium group, for example, a quaternary ammonium group, and a negatively charged group including a phosphate group, a sulfonate group, or a carboxylate group. In some embodiments of the coating method, at least one of the zwitterions includes a betaine, a phosphatidylcholine, a lysophosphatidylcholine, a phosphatidylserine, a lysophosphatidylserine, a hydroxylsultaine, or an amphoacetate salt.

### EXAMPLES

### Example 1

### Coated Mandarins

Coating agents A and B having the compositions shown in Table 1 were prepared.

TABLE 1
Coating Agent Compositions

| | |
|---|---|
| A | B |

| Glyceryl | 95 | wt % | 95 | wt % |
|---|---|---|---|---|
| Monostearate* | | | | |
| Sodium Stearate | 5 | wt % | 4 | wt % |

| | | | |
|---|---|---|---|
| Cocamidopropyl | — | 1 | wt % |

Betaine

*equilibrium mixture of 2,3-dihydroxypropan-1-yl octadecanoate and 1,3-dihydroxypropan-2-yl octadecanoate (molar ratio of about 90:10)

Mixtures 1, 2, and 3 of coating agents A and B dispersed in water at the concentrations shown in Table 2 were prepared. For each of Mixtures 1, 2, and 3, groups of 120 unwaxed mandarins of the same size, quality, ripeness, pack date, and orchard were coated by dipping each mandarin into a bowl of the mixture and then drying in a rolling, translating heat tunnel at 65-70° C. for 100 seconds. Mass loss of the coated mandarins and a comparative group of uncoated mandarins was then measured. Results are shown in Table 2.

TABLE 2
Mixture Compositions, Mass Loss of Mandarins

| | Coating Agent | Concentration | | Mass Loss Factor* |
|---|---|---|---|---|
| Mixture 1 | A | 50 | g/L | 1.42 |
| Mixture 2 | B | 50 | g/L | 1.62 |
| Mixture 3 | B | 100 | g/L | 1.83 |

| | | | |
|---|---|---|---|
| Untreated | — | — | 1 |

*ratio of the average mass loss rate of untreated control to the average mass loss rate of corresponding tested produce for a given period of time

As shown in Table 2, coatings formed from coating agents including a fatty acid salt and a zwitterion better reduced mass loss from produce than coatings lacking a zwitterion.

### Example 2

### Coated Mandarins

Coating agents C and D having the compositions shown in Table 3 were prepared.

TABLE 3
Coating Agent Compositions

| | |
|---|---|
| C | D |

| | | | | |
|---|---|---|---|---|
| Glyceryl | 94.8 | wt % | 94.8 | wt % |
| Monostearate | | | | |
| Sodium Stearate | 5 | wt % | 4 | wt % |

| | | | |
|---|---|---|---|
| Cocamidopropyl | — | 1 | wt % |
| Betaine | | | |

| | | | | |
|---|---|---|---|---|
| NaCl | 0.2 | wt % | 0.2 | wt % |

Mixtures 4-7 of coating agents A, C, and D dispersed in water at the concentrations shown in Table 4 were prepared. For each of Mixtures 4-7, groups of 120 unwaxed mandarins of the same size, quality, ripeness, pack date, and orchard were coated by dipping each mandarin into a bowl of the mixture and then drying in a rolling, translating heat tunnel at 65-70° C. for 100 seconds. Mass loss of the coated mandarins and a comparative group of uncoated mandarins was then measured. Results are shown in Table 4.

TABLE 4
Mixture Compositions, Mass Loss of Mandarins

| | Coating Agent | Concentration | | Mass Loss Factor |
|---|---|---|---|---|
| Mixture 4 | A | 50 | g/L | 1.90 |
| Mixture 5 | C | 50.1 | g/L | 1.95 |
| Mixture 6 | C | 100.2 | g/L | 2.60 |
| Mixture 7 | D | 100.2 | g/L | 3.27 |

| | | | |
|---|---|---|---|
| Untreated | — | — | 1 |

As shown in Table 4, coatings formed from coating agents including a fatty acid salt, a zwitterion, and an inorganic salt better reduced mass loss from produce than coatings lacking a zwitterion and/or an inorganic salt.

### Example 3

### Dispersion Viscoelastic Properties

Coating agents E and F having the compositions shown in Table 5 were prepared.

TABLE 5
Coating Agent Compositions

| | |
|---|---|
| E | F |

| | | | | |
|---|---|---|---|---|
| Glyceryl | 94.97 | wt % | 94.92 | wt % |
| Monostearate | | | | |
| Sodium Stearate | 5 | wt % | 5 | wt % |
| NaCl | 0.03 | wt % | 0.08 | wt % |

Mixtures 8-10 of coating agents A, E, and F dispersed in water at the concentrations shown in Table 6 were prepared.

TABLE 6
Mixture Compositions

| Mixture | Coating Agent | Concentration |
|---|---|---|
| 8 | A | 60 g/L |
| 9 | E | 60 g/L |
| 10 | F | 60 g/L |

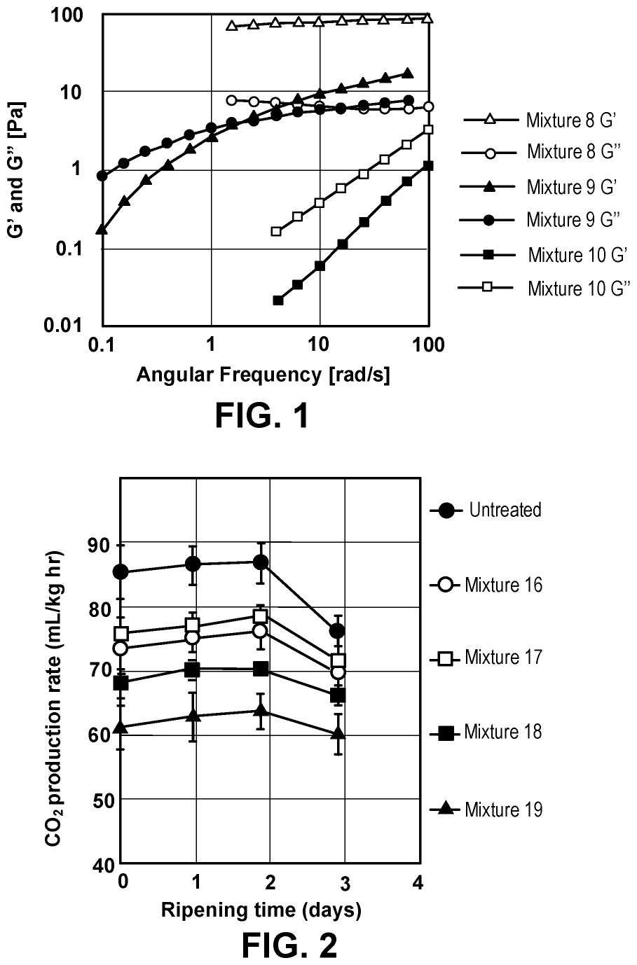

The storage modulus G′ and loss modulus G″ of each of Mixtures 8-10 was measured as a function of angular frequency (rad/s), swept at 0.2% oscillation strain with the solution at 55° C. The results are shown in FIG. 1.

Mixture 10 appeared to be a viscoelastic fluid, while Mixture 8 appeared to be a gel. This viscoelastic shift as a function of NaCl concentration, as shown in FIG. 1, can provide improved mixability and access to higher concentrations of the coating agent.

### Example 4

### Coated Mandarins

Coating agents G-J having the compositions shown in Table 7 were prepared.

TABLE 7
Coating Agent Compositions

| | G | | H | | I | | J | |
|---|---|---|---|---|---|---|---|---|
| Glyceryl | 95 | wt % | 95 | wt % | 95 | wt % | 95 | wt % |
| Monostearate | | | | | | | | |
| Sodium Stearate | 2 | wt % | 2 | wt % | 2 | wt % | 2 | wt % |

| | | | | | |
|---|---|---|---|---|---|
| Phosphatidylcholine* | 3 | wt % | — | — | — |

| | | | | | |
|---|---|---|---|---|---|
| Lyso- | — | 3 | wt % | — | — |

| phosphatidylcholine | | | | |
|---|---|---|---|---|
| Lecithin | — | — | 3 | wt % |

| | | | | | |
|---|---|---|---|---|---|
| Lysolecithin | — | — | — | 3 | wt % |

*Phospholipon ® (Lipoid LLC, Newark, NJ)

Mixtures 11-15 of coating agents A and G-J dispersed in water at the concentrations shown in Table 8 were prepared. For each of Mixtures 11-15, groups of 120 unwaxed mandarins of the same size, quality, ripeness, pack date, and orchard were coated by dipping each mandarin into a bowl of the mixture and then drying in a rolling, translating heat tunnel at 65-70° C. for 100 seconds. Mass loss of the coated mandarins and a comparative group of uncoated mandarins was then measured. Results are shown in Table 8.

TABLE 8
Mixture Compositions, Mass Loss of Mandarins

| | Coating Agent | Concentration | Mass Loss Factor |
|---|---|---|---|
| Mixture 11 | A | 50 g/L | 2.83 |
| Mixture 12 | G | 50 g/L | 3.10 |
| Mixture 13 | H | 50 g/L | 3.57 |
| Mixture 14 | I | 50 g/L | 3.21 |
| Mixture 15 | J | 50 g/L | 3.70 |
| Untreated | — | — | 1 |

As shown in Table 8, coatings formed from coating agents including a fatty acid salt and a zwitterion better reduced mass loss from produce than coatings lacking a zwitterion.

### Example 5

### Coated Avocados

Coating agents K-M having the compositions shown in Table 9 were prepared.

TABLE 9
Coating Agent Compositions

| | | |
|---|---|---|
| K | L | M |

| | | | | | | |
|---|---|---|---|---|---|---|
| Glyceryl | 95 | wt % | 95 | wt % | 95 | wt % |
| Monostearate | | | | | | |
| Sodium Stearate | 4 | wt % | 2.5 | wt % | 1 | wt % |
| Phosphatidylcholine | 1 | wt % | 2.5 | wt % | 4 | wt % |

Mixtures 16-19 of coating agents A and K-M dispersed in water at the concentrations shown in Table 10 were prepared. For each of Mixtures 16-19, groups of 120 California avocados of the same size, quality, ripeness, pack date, and orchard were coated by dipping each avocado into a bowl of the mixture and then drying in a rolling, translating heat tunnel at 65-70° C. for 100 seconds. Mass loss and respiration production of the coated avocados and a comparative group of uncoated avocados was then measured. Results are shown in Table 10 and FIG. 2.

TABLE 10
Mixture Compositions, Mass Loss of Avocados

| | Coating Agent | Concentration | Mass Loss Factor |
|---|---|---|---|
| Mixture 16 | A | 30 g/L | 1.41 |
| Mixture 17 | K | 30 g/L | 1.49 |
| Mixture 18 | L | 30 g/L | 1.68 |
| Mixture 19 | M | 30 g/L | 1.90 |
| Untreated | — | — | 1 |

As shown in Table 10 and FIG. 2, coatings formed from coating agents including an increased ratio of zwitterion to fatty acid salt better reduced mass loss and respiration production from produce.

### Example 6

### Coated Avocados

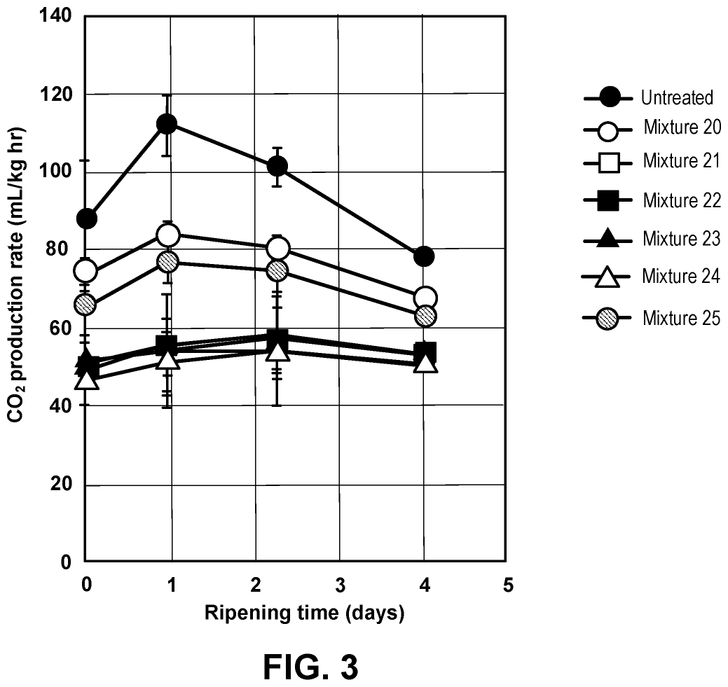

Mixtures 20-25 of coating agents A and J dispersed in water at the concentrations shown in Table 11 were prepared. For each of Mixtures 20-25, groups of 120 California avocados of the same size, quality, ripeness, pack date, and orchard were coated by spraying the solution onto each avocado on a brush bed and then drying in a rolling, translating heat tunnel at 65-70° C. for 100 seconds. Mass loss and respiration production of the coated avocados and a comparative group of uncoated avocados was then measured. Results are shown in Table 11 and FIG. 3.

TABLE 11
Mixture Compositions, Mass Loss of Avocados

| | Coating Agent | Concentration | Mass Loss Factor |
|---|---|---|---|
| Mixture 20 | A | 15 g/L | 1.65 |
| Mixture 21 | A | 30 g/L | 1.99 |
| Mixture 22 | A | 45 g/L | 2.26 |
| Mixture 23 | J | 15 g/L | 1.87 |
| Mixture 24 | J | 30 g/L | 2.40 |
| Mixture 25 | J | 45 g/L | 2.69 |
| Untreated | — | — | 1 |

As shown in Table 11 and FIG. 3, coatings formed from coating agents including 3 wt % lysolecithin, applied at a range of coating agent concentrations, reduced mass loss and respiration production from produce.

### Example 7

### Coated Limes

Coating agents N-R having the compositions shown in Table 12 were prepared.

TABLE 12
Coating Agent Compositions

| | N | | O | | P | | Q | | R | |
|---|---|---|---|---|---|---|---|---|---|---|
| Glyceryl | 91.2 | wt % | 91.2 | wt % | 91.2 | wt % | 92.4 | wt % | 92.4 | wt % |
| Monostearate | | | | | | | | | | |
| Glyceryl | 4 | wt % | 4 | wt % | 4 | wt % | 2.7 | wt % | 2.7 | wt % |
| Monolaurate* | | | | | | | | | | |
| Sodium Stearate | 4.8 | wt % | 1.9 | wt % | 1.9 | wt % | 4.9 | wt % | 2 | wt % |

| | | | | | | | |
|---|---|---|---|---|---|---|---|
| Lysolecithin | — | 2.9 | wt % | — | — | 2.9 | wt % |

| | | | | | | |
|---|---|---|---|---|---|---|
| Lyso- | — | — | 2.9 | wt % | — | — |

phosphatidylcholine

*equilibrium mixture of 2,3-dihydroxypropan-1-yl dodecanoate and 1,3-dihydroxypropan-2-yl dodecanoate (molar ratio of about 90:10)

Mixtures 26-33 of coating agents A, J, and N-R dispersed in water at the concentrations shown in Table 13 were prepared. For each of Mixtures 26-33, groups of 120 limes of the same size, quality, ripeness, pack date, and orchard were coated by dipping each lime into a bowl of the mixture and then drying in a rolling, translating heat tunnel at 65-70° C. for 100 seconds. Mass loss of the coated limes and a comparative group of uncoated limes was then measured. Results are shown in Table 13.

TABLE 13
Mixture Compositions, Mass Loss of Limes

| | Coating Agent | Concentration | Mass Loss Factor |
|---|---|---|---|
| Mixture 26 | A | 50 g/L | 1.38 |
| Mixture 27 | J | 50 g/L | 1.68 |
| Mixture 28 | N | 50 g/L | 1.69 |
| Mixture 29 | O | 50 g/L | 2.18 |
| Mixture 30 | P | 50 g/L | 2.48 |
| Mixture 31 | A | 75 g/L | 1.67 |
| Mixture 32 | Q | 75 g/L | 2.01 |
| Mixture 33 | R | 75 g/L | 2.89 |
| Untreated | — | — | 1 |

As shown in Table 13, coatings formed from coating agents including an a fatty acid salt, a zwitterion, and glyceryl monolaurate better reduced mass loss and respiration production from produce.

### Example 8

### Coated Tangerines

Coating agents S-U having the compositions shown in Table 14 were prepared.

TABLE 14
Coating Agent Compositions

| | | |
|---|---|---|
| S | T | U |

| | | | | | | |
|---|---|---|---|---|---|---|
| Glyceryl | 95 | wt % | 90 | wt % | 85 | wt % |
| Monostearate | | | | | | |
| Sodium Stearate | 3 | wt % | 5 | wt % | 5 | wt % |
| Lysolecithin | 2 | wt % | 5 | wt % | 10 | wt % |

Mixtures 34-38 of coating agents A, J, and S-U dispersed in water at the concentrations shown in Table 15 were prepared. For each of Mixtures 34-38, groups of 120 unwaxed tangerines of the same size, quality, ripeness, pack date, and orchard were coated by dipping each tangerine into a bowl of the mixture and then drying in a rolling, translating heat tunnel at 65-70° C. for 100 seconds. Mass loss of the coated tangerines and a comparative group of uncoated tangerines was then measured. Results are shown in Table 15.

TABLE 15
Mixture Compositions, Mass Loss of Tangerines

| | Coating Agent | Concentration | Mass Loss Factor |
|---|---|---|---|
| Mixture 34 | A | 50 g/L | 2.53 |
| Mixture 35 | S | 50 g/L | 2.74 |
| Mixture 36 | J | 50 g/L | 3.11 |
| Mixture 37 | T | 50 g/L | 2.52 |
| Mixture 38 | U | 50 g/L | 2.26 |
| Untreated | — | — | 1 |

As shown in Table 15, for a given ratio of fatty acid salt and zwitterion to monoglyceride, coatings formed from coating agents including an increased ratio of zwitterion to fatty acid salt better reduced mass loss and respiration production from produce.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A composition comprising:
one or more monoglycerides of a C₄-C₂₈ fatty acid, present in a total amount of about 40 wt % to about 99 wt % of the composition;
one or more salts of a C₄-C₂₈ fatty acid, present in a total amount of about 0.1 wt % to about 20 wt % of the composition; and
one or more zwitterions, present in a total amount of 0.1 wt % to about 20 wt % of the composition.

2. The composition of claim 1, further comprising an inorganic salt.

3. A composition comprising:
one or more monoglycerides of a C₄-C₂₈ fatty acid;
one or more salts of a C₄-C₂₈ fatty acid; and
one or more zwitterions;
wherein a ratio of a total number of moles of the one or more monoglycerides to a total number of moles of the one or more salts and the one or more zwitterions is about 100:1 to about 4:1.

4. The composition of claim 3, wherein a ratio of a total number of moles of the one or more salts to a total number of moles of the one or more zwitterions is about 10:1 to about 1:10.

5. The composition of claim 1, wherein the composition comprises a lecithin or a hydrolyzed lecithin comprising at least one of the zwitterions.

6. The composition of claim 1, wherein at least one of the zwitterions comprises:
a positively charged group comprising a quaternary ammonium group or a phosphonium group; and
a negatively charged group comprising a phosphate group, a sulfonate group, or a carboxylate group.

7. The composition of claim 1, wherein at least one of the zwitterions comprises a compound of Formula III-i or Formula III-ii: 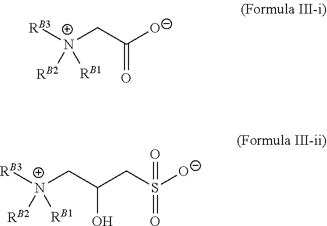
wherein:
R^{B1}, R^{B2}, and R^{B3} are each independently selected from C₁-C₂₂ alkyl and (C₁-C₆ alkyl)-NR^{B4}C(O)R^{H};
each occurrence of R^{B4} is independently H or C₁-C₆ alkyl; and
each occurrence of R^{H} is independently a C₃-C₂₁ side chain.

8. The composition of claim 1, wherein at least one of the zwitterions comprises a compound of Formula IIIA-i or Formula IIIA-ii: 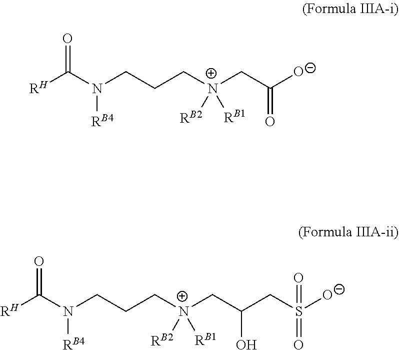
wherein:
R^{B1} and R^{B2} are each independently selected from C₁-C₆ alkyl;
R^{B4} is H or C₁-C₆ alkyl; and
R^{H} is a C₃-C₂₁ side chain.

9. The composition of claim 1, wherein at least one of the zwitterions comprises a compound of Formula IV: 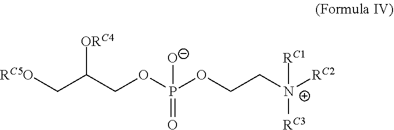
wherein:
R^{C1}, R^{C2}, and R^{C3} are each independently selected from C₁-C₆ alkyl;
R^{C4} and R^{C5} are each independently selected from H and C(O)R^{H};
each occurrence of R^{H} is independently a C₃-C₂₁ side chain; and
at least one of R^{C4} and R^{C5} is not H.

10. The composition of claim 1, wherein each of the one or more monoglycerides independently comprises a compound of Formula I-i or Formula I-ii: 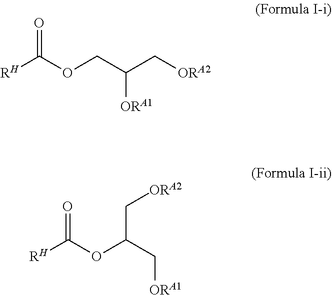
wherein:
R^{A1} and R^{A2} are each independently selected from H and C₁-C₆ alkyl; and
R^{H} is a C₃-C₂₇ side chain.

11. The composition of claim 1, wherein each of the one or more salts independently comprises a compound of Formula II: 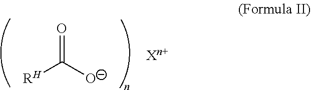
wherein:
R^{H} is a C₃-C₂₇ side chain; and
Xⁿ⁺ is a cationic moiety having formal charge n.

12. The composition of claim 11, wherein
Xⁿ⁺ is selected from Li⁺, Na⁺, K⁺, Cs⁺, Ag⁺, Ca²⁺, Mg²⁺, Zn²⁺, Cu²⁺, and (R^{D})₄N⁺, and
each occurrence of R^{D} is selected from H, C₁-C₆ alkyl, C₃-C₆ cycloalkyl, C₃-C₆ heterocycloalkyl, aryl, and heteroaryl, wherein
each C₁-C₆ alkyl is optionally substituted with 1-3 R^{E} independently selected from C₃-C₆ cycloalkyl, C₃-C₆ heterocycloalkyl, aryl, and heteroaryl; and
optionally, one or more instances of R^{D} are taken together with the nitrogen atom to which they are attached to form a C₃-C₆ heterocycloalkyl.

13. A mixture comprising:
the composition of claim 1; and
a solvent.

14. A coated agricultural product comprising an agricultural product and a layer disposed on a surface of the agricultural product, wherein the layer comprises the composition of claim 1.

15. A method of coating an agricultural product, the method comprising:
contacting a surface of the agricultural product with a mixture comprising a coating agent and a solvent, wherein the coating agent comprises
one or more monoglycerides of a C₄-C₂₈ fatty acid;
one or more salts of a C₄-C₂₈ fatty acid; and
one or more zwitterions;
wherein a ratio of a total number of moles of the one or more monoglycerides to a total number of moles of the one or more salts and the one or more zwitterions is about 100:1 to about 4:1; and
removing at least a portion of the solvent to form a coating on the surface of the agricultural product.

16. The method of claim 15, wherein the coating agent further comprises one or more inorganic salts.

17. The method of claim 16, wherein a concentration of a total amount of the one or more inorganic salts in the mixture is about 5 ppm to about 500 ppm, calculated on a weight basis.

18. The method of claim 15, wherein the coating agent comprises a lecithin, a hydrolyzed lecithin, or a combination thereof, comprising at least one of the zwitterions.

19. The method of claim 15, wherein at least one of the zwitterions comprises
a positively charged group comprising a quaternary ammonium group or a phosphonium group; and
a negatively charged group comprising a phosphate group, a sulfonate group, or a carboxylate group.

20. The method of claim 15, wherein at least one of the zwitterions comprises a betaine, a phosphatidylcholine, a lysophosphatidylcholine, a hydroxysultaine, or an amphoacetate salt.
